(19) United States
(12) Patent Application Publication
(10) Pub. No.: US 2025/0100145 A1
(43) Pub. Date: Mar. 27, 2025

(54) INFORMATION PROCESSING SYSTEM, INFORMATION PROCESSING METHOD, AND INFORMATION PROCESSING PROGRAM

(71) Applicant: FUJIFILM CORPORATION, Tokyo (JP)

(72) Inventors: Yasuhisa KANEKO, Tokyo (JP); Kenji NAGAMIYA, Tokyo (JP); Tomohide HIRAGAMI, Tokyo (JP)

(21) Appl. No.: 18/889,385

(22) Filed: Sep. 19, 2024

(30) Foreign Application Priority Data
Sep. 26, 2023 (JP) 2023-163989

(51) Int. Cl. B25J 9/16; G05B 19/4155

(52) U.S. Cl. CPC B25J 9/1676; G05B 19/4155; G05B 2219/40195

(57) ABSTRACT

An information processing system including at least one processor, wherein the processor is configured to: acquire motion information indicating a motion of an operator who operates a movable unit of a robot; and control the robot such that the robot is switched from an operation mode in which the movable unit is in an operable state to a non-operation mode in which the movable unit is in an inoperable state in a case where the motion information satisfies a predetermined first condition.

### CROSS-REFERENCE TO RELATED APPLICATIONS

This application claims priority from Japanese Application No. 2023-163989, filed on Sep. 26, 2023, the entire disclosure of which is incorporated herein by reference.

### BACKGROUND

### Technical Field

The technology of the present disclosure relates to an information processing system, an information processing method, and an information processing program.

### Related Art

In the related art, with the development of technologies related to virtual reality (VR), augmented reality (AR), and mixed reality (MR), a method called tele-existence, in which a person remotely operates a robot, has been developed. The tele-existence receives an operation by an operator while making the operator perceive peripheral information of the robot detected by a camera, a microphone, and the like attached to the robot. The operator can operate the robot while feeling as if the operator is present in the same environment as the robot.

For example, WO2017/033367A discloses a technique in which an operator who is at a position separated from a robot arm performs a non-contact action to operate the robot arm while checking a video captured by a camera provided in the robot arm.

In recent years, a technique has been required that applies the tele-existence to allow a robot to perform tasks instead of a person in an area in which an operator has restrictions on entering, leaving or staying (hereinafter, referred to as a restricted area). Examples of the restricted area include a radiation controlled area, a high magnetic field controlled area, a biohazard controlled area, an aseptic room, an intensive care room, and a clean room.

On the other hand, it is considered that no one enters and leaves the restricted area at all, but persons including an operator of a robot enter and leave the restricted area as necessary. In a case where the robot makes an unexpected motion for the person who enters and leaves the restricted area, the robot is likely to hinder the work performed by the person, or the robot and the person are likely to collide with each other. Therefore, a technique is needed that prevents the robot from making an unexpected motion for the person who enters and leaves the restricted area.

### SUMMARY

The present disclosure provides an information processing system, an information processing method, and an information processing program that can appropriately operate a robot.

According to a first aspect of the present disclosure, there is provided an information processing system comprising at least one processor configured to: acquire motion information indicating a motion of an operator who operates a movable unit of a robot; and control the robot such that the robot is switched from an operation mode in which the movable unit is in an operable state to a non-operation mode in which the movable unit is in an inoperable state in a case where the motion information satisfies a predetermined first condition.

In the above-described aspect, the processor may be configured to: acquire operation information for the movable unit that is input by the operator; control the robot such that the robot makes a motion corresponding to the operation information in a case of the operation mode; and discard the operation information in a case of the non-operation mode.

In the above-described aspect, the processor may be configured to generate the operation information causing the movable unit to be operated in operative association with the motion information in a case of the operation mode.

In the above-described aspect, the processor may be configured to control the robot such that the robot is switched from the operation mode to the non-operation mode in a case where the motion information indicates that the operator has entered a predetermined area as the first condition.

In the above-described aspect, the predetermined area may be an area within a predetermined range from the robot.

In the above-described aspect, the predetermined area may be at least one of a radiation controlled area, a high magnetic field controlled area, a biohazard controlled area, an aseptic room, an intensive care room, or a clean room, and the robot may be operated in the predetermined area.

In the above-described aspect, the robot may include a detection unit of at least one of a sensor, a camera, or a microphone, and the processor may be configured to: acquire detection information acquired by the detection unit of the robot; and output the detection information to at least one output device.

In the above-described aspect, the processor may be configured to stop the output of the detection information to the output device in a case where the motion information satisfies a predetermined second condition.

In the above-described aspect, the processor may be configured to: acquire assistant motion information indicating a motion of an assistant other than the operator; and control the robot such that the robot is switched from the operation mode to the non-operation mode in a case where the assistant motion information satisfies a predetermined third condition.

In the above-described aspect, the processor may be configured to: output the detection information to a first output device associated with the operator in advance and a second output device associated with an assistant other than the operator in advance; acquire assistant motion information indicating a motion of the assistant; and stop the output of the detection information to the second output device in a case where the assistant motion information satisfies a predetermined fourth condition.

In the above-described aspect, a function other than the movable unit included in the robot may not be stopped in the non-operation mode.

In the above-described aspect, the robot may include at least one of a movement mechanism or an operation mechanism as the movable unit.

In the above-described aspect, the motion information may indicate a movement of at least one of a predetermined body part, a line of sight, a voice, a brain wave, or a position of the operator.

According to a second aspect of the present disclosure, there is provided an information processing method executed by a computer. The method comprises: acquiring motion information indicating a motion of an operator who operates a movable unit of a robot; and controlling the robot such that the robot is switched from an operation mode in which the movable unit is in an operable state to a non-operation mode in which the movable unit is in an inoperable state in a case where the motion information satisfies a predetermined first condition.

According to a third aspect of the present disclosure, there is provided an information processing program causing a computer to execute a process comprising: acquiring motion information indicating a motion of an operator who operates a movable unit of a robot; and controlling the robot such that the robot is switched from an operation mode in which the movable unit is in an operable state to a non-operation mode in which the movable unit is in an inoperable state in a case where the motion information satisfies a predetermined first condition.

According to the above-described aspects, the information processing system, the information processing method, and the information processing program of the present disclosure can appropriately operate the robot.

### BRIEF DESCRIPTION OF THE DRAWINGS

FIG. 1 is a schematic diagram illustrating an example of an overall configuration of an information processing system according to a first embodiment.

FIG. 2 is a block diagram illustrating an example of a hardware configuration of an information processing apparatus, a robot, a modality, and a terminal apparatus.

FIG. 3 is a schematic diagram illustrating an example of an appearance of the robot.

FIG. 4 is a schematic diagram illustrating an example of a usage aspect of the robot and the modality.

FIG. 5 is a block diagram illustrating an example of a functional configuration of the information processing apparatus.

FIG. 6 is a diagram illustrating a non-operation mode of the robot.

FIG. 7 is a diagram illustrating disconnection from the robot.

FIG. 8 is a flowchart illustrating an example of information processing.

FIG. 9 is a schematic diagram illustrating an example of an overall configuration of an information processing system according to a second embodiment.

FIG. 10 is a diagram illustrating a non-operation mode of a robot.

FIG. 11 is a diagram illustrating disconnection from the robot.

### DETAILED DESCRIPTION

Hereinafter, embodiments of the present disclosure will be described with reference to the drawings.

### FIRST EMBODIMENT

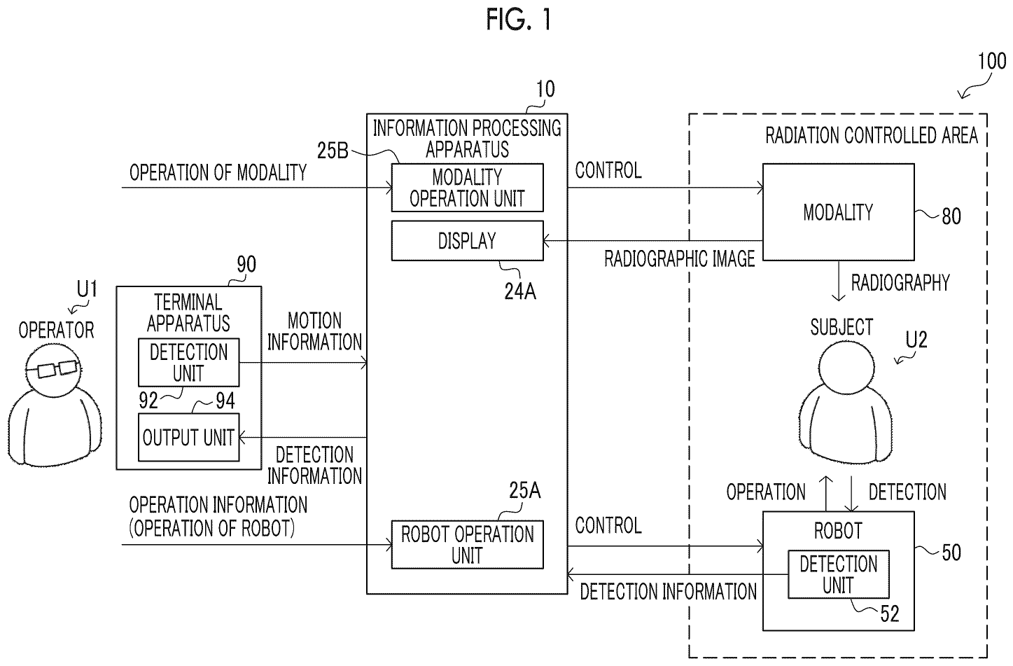

First, an information processing system 100 according to the present embodiment will be described with reference to FIGS. 1 to 4. FIG. 1 is a schematic diagram illustrating an example of an overall configuration of the information processing system 100. As illustrated in FIG. 1, the information processing system 100 comprises an information processing apparatus 10, a robot 50, a modality 80, and a terminal apparatus 90. The information processing apparatus 10 is configured to be connectable to each of the robot 50, the modality 80, and the terminal apparatus 90 via a wired or wireless network.

The information processing apparatus 10 has a console function for controlling the modality 80 in response to an operation of an operator U1. For example, the modality 80 according to the present embodiment is a computed tomography (CT) apparatus that performs radiography on a subject U2. The modality 80 performs radiography on the subject U2 under the control of the information processing apparatus 10 and transmits an obtained radiographic image to the information processing apparatus 10. The information processing apparatus 10 performs control to display the radiographic image received from the modality 80 on a display 24A.

In a case where radiography is performed, the operator U1 makes an advance preparation, such as positioning of the subject U2, in a radiation controlled area, leaves the radiation controlled area, and inputs an instruction to start radiography using a modality operation unit 25B of the information processing apparatus 10 (console) that is disposed outside the radiation controlled area. In a case where the radiography is completed, the operator U1 enters the radiation controlled area again and performs post-processing such as canceling the positioning of the subject U2. As described above, during the emission of radiation and a period before and after the emission of the radiation, the operator U1 moves away from the subject U2 to avoid unnecessary exposure to the radiation. However, it may be difficult for the operator U1 to directly monitor the aspect of the subject U2 in close proximity to the subject U2 during radiography.

Therefore, in the information processing system 100 according to the present embodiment, the robot 50 having a detection function of a camera or the like is disposed near the subject U2 (that is, the radiation controlled area), and the aspect of the subject U2 is detected while the robot 50 is being moved to change a position, a direction, and the like. This makes it possible for the operator U1 who is located at a place away from the subject U2 to monitor the aspect of the subject U2 in detail. FIG. 1 illustrates a flow of the exchange of information in a state in which the operator U1 and the subject U2 are separated from each other.

Specifically, the robot 50 detects the image, motion, voice, and the like of the subject U2 using the detection unit 52 and transmits detection information (that is, information indicating the aspect of the subject U2) to the information processing apparatus 10. The information processing apparatus 10 transmits the detection information received from the robot 50 to the terminal apparatus 90 owned by the operator U1. The terminal apparatus 90 outputs the detection information received from the information processing apparatus 10 to an output unit 94. Therefore, the operator U1 can monitor the aspect of the subject U2 detected by the robot 50 using the terminal apparatus 90 owned by the operator U1.

In addition, the robot 50 is moved to a position where the robot 50 can easily monitor the aspect of the subject U2 or provides, for example, assistance to the subject U2 in the radiation controlled area in response to the operation of the operator U1 input through a robot operation unit 25A of the information processing apparatus 10.

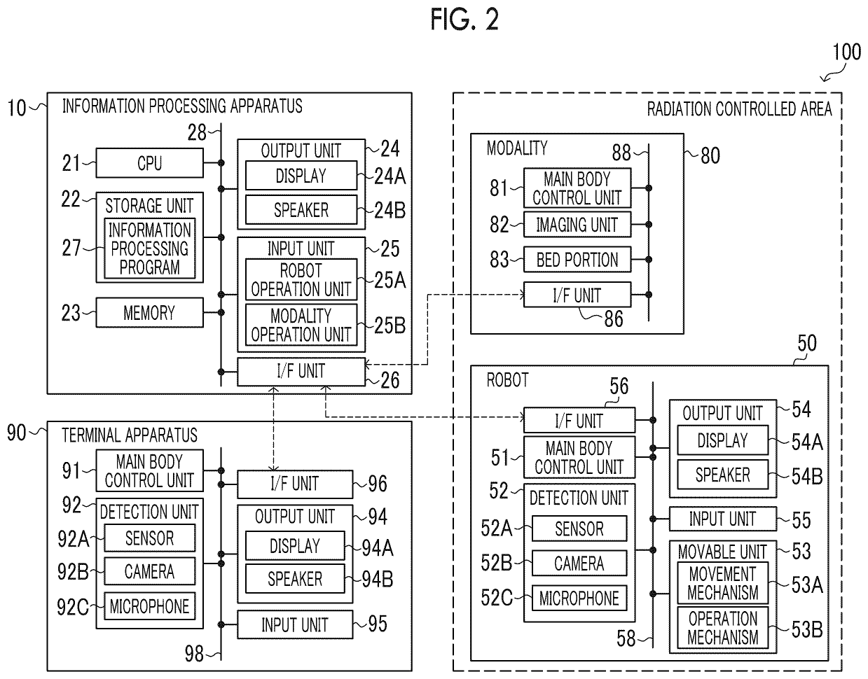

An example of a hardware configuration of the information processing apparatus 10, the robot 50, the modality 80, and the terminal apparatus 90 will be described with reference to FIG. 2.

As illustrated in FIG. 2, the information processing apparatus 10 comprises a central processing unit (CPU) 21, a nonvolatile storage unit 22, and a memory 23 as a temporary storage area. In addition, the information processing apparatus 10 comprises an output unit 24 including a display 24A and a speaker 24B and an input unit 25 such as a touch panel, a keyboard, a mouse, a switch, or a button. The input unit 25 also functions as the robot operation unit 25A for operating the robot 50 and a modality operation unit 25B for operating the modality 80.

Further, the information processing apparatus 10 comprises an interface (I/F) unit 26 that performs wired or wireless communication with the robot 50, the terminal apparatus 90, the modality 80, other external apparatuses, and the like. The CPU 21, the storage unit 22, the memory 23, the output unit 24, the input unit 25, and the I/F unit 26 are connected via a bus 28, such as a system bus or a control bus, such that they can exchange various types of information with one another.

The storage unit 22 is implemented by a storage medium such as a hard disk drive (HDD), a solid state drive (SSD), or a flash memory. An information processing program 27 of the information processing apparatus 10 is stored in the storage unit 22. The CPU 21 reads out the information processing program 27 from the storage unit 22, deploys the information processing program 27 in the memory 23, and executes the deployed information processing program 27. The CPU 21 is an example of a processor according to the present disclosure. For example, a personal computer, a server computer, a smartphone, a tablet terminal, a wearable terminal, and the like can be appropriately applied as the information processing apparatus 10.

As illustrated in FIG. 2, the robot 50 comprises a main body control unit 51 that is implemented to include a CPU, a read only memory (ROM), a random access memory (RAM), and the like which are not illustrated. In addition, the robot 50 comprises an output unit 54 including a display 54A and a speaker 54B and an input unit 55 such as a touch panel, a keyboard, a mouse, a switch, or a button. Further, the robot 50 comprises an I/F unit 56 that performs wired or wireless communication with the information processing apparatus 10, other external apparatuses, and the like.

Furthermore, the robot 50 comprises the detection unit 52 for detecting detection information such as the motion and voice of the subject U2 near the robot 50. For example, the detection unit 52 is at least one of a sensor 52A, a camera 52B, or a microphone 52C. For example, an acceleration sensor, a gyro sensor, a geomagnetic sensor, a temperature sensor, a distance-measuring sensor, and the like can be applied as the sensor 52A. The distance-measuring sensor is a sensor that measures a distance to an object and is, for example, Laser Imaging Detection and Ranging or Light Detection and Ranging (LIDAR), a time-of-flight (TOF) camera, a stereo camera, or the like. The detection information detected by the detection unit 52 is output to the information processing apparatus 10 via the I/F unit 56 and is further output from the information processing apparatus 10 to the terminal apparatus 90.

Moreover, the robot 50 comprises a movable unit 53 that is controlled according to operation information input by the operator U1 through the robot operation unit 25A of the information processing apparatus 10. For example, the movable unit 53 is at least one of a movement mechanism 53A or an operation mechanism 53B.

The movement mechanism 53A is a mechanism for running and rotating the entire robot 50 and is configured to include, for example, wheels and a drive mechanism for the wheels. The operation mechanism 53B is a mechanism for the robot 50 to perform, for example, operations of grasping, moving, and rotating a neighboring object and is configured to include, for example, a robot arm and a drive mechanism for the robot arm. The operation mechanism 53B can be used, for example, to hold an intravenous tube, an electrocardiogram cable, and the like connected to the subject U2 so as not to interfere with imaging.

In the robot 50, the main body control unit 51, the detection unit 52, the movable unit 53, the output unit 54, the input unit 55, and the I/F unit 56 are connected via a bus 58, such as a system bus or a control bus, such that they can exchange various types of information with one another.

As illustrated in FIG. 2, the modality 80 comprises a main body control unit 81 that is implemented to include a CPU, a ROM, a RAM, and the like which are not illustrated. Further, the modality 80 comprises an imaging unit 82 for performing radiography and a bed portion 83 on which the subject U2 lies down during the radiography. In addition, the modality 80 comprises an I/F unit 86 that performs wired or wireless communication with the information processing apparatus 10, other external apparatuses, and the like. In the modality 80, the main body control unit 81, the imaging unit 82, the bed portion 83, and the I/F unit 86 are connected via a bus 88, such as a system bus or a control bus, such that they can exchange various types of information with one another.

As illustrated in FIG. 2, the terminal apparatus 90 comprises a main body control unit 91 that is implemented to include a CPU, a ROM, a RAM, and the like which are not illustrated. In addition, the terminal apparatus 90 comprises an output unit 94 including a display 94A and a speaker 94B and an input unit 95 such as a touch panel, a keyboard, a mouse, a switch, or a button. Further, the terminal apparatus 90 comprises an I/F unit 96 that performs wired or wireless communication with the information processing apparatus 10, other external apparatuses, and the like.

Furthermore, the terminal apparatus 90 comprises a detection unit 92 for detecting motion information such as the motion and voice of the operator U1. For example, the detection unit 92 is at least one of a sensor 92A, a camera 92B, or a microphone 92C for detecting the operation of the operator U1. For example, an acceleration sensor, a gyro sensor, a geomagnetic sensor, a temperature sensor, a distance-measuring sensor, and the like can be applied as the sensor 92A. The distance-measuring sensor is a sensor that measures a distance to an object and is, for example, a LIDAR, a TOF camera, a stereo camera, or the like. The motion information of the operator U1 detected by the detection unit 92 is output to the information processing apparatus 10 via the I/F unit 96.

Moreover, the terminal apparatus 90 may output the motion information of the operator U1 detected by the detection unit 92 to the output unit 94 of the terminal apparatus 90, the output unit 24 of the information processing apparatus 10, the output unit 54 of the robot 50, and the like. That is, a configuration may be adopted such that the operator U1 and the subject U2 can check the motion information of the operator U1. In the terminal apparatus 90, the main body control unit 91, the detection unit 92, the output unit 94, the input unit 95, and the I/F unit 96 are connected via a bus 98, such as a system bus or a control bus, such that they can exchange various types of information with one another. For example, a smartphone, a wearable terminal, a tablet terminal, a personal computer, and the like can be appropriately applied as the terminal apparatus 90. Examples of the wearable terminal include a head-mounted display, smart glasses, and a smart watch.

In addition, in the example illustrated in FIGS. 1 and 2, the form in which the robot operation unit 25A and the modality operation unit 25B are included in the information processing apparatus 10 has been described. However, the present disclosure is not limited thereto. For example, instead of or in addition to the information processing apparatus 10, the terminal apparatus 90 may have the functions of at least one of the robot operation unit 25A or the modality operation unit 25B. In addition, for example, instead of or in addition to the information processing apparatus 10, the robot 50 may have the functions of at least one of the robot operation unit 25A or the modality operation unit 25B. Further, for example, instead of or in addition to the information processing apparatus 10, a dedicated operation terminal (for example, a smartphone) may have the functions of at least one of the robot operation unit 25A or the modality operation unit 25B.

Furthermore, in the examples illustrated in FIGS. 1 and 2, the form in which the information processing apparatus 10 controls both the robot 50 and the modality 80 has been described. However, the present disclosure is not limited thereto. The information processing apparatus 10 may be configured by, for example, two consoles of a console for controlling the robot 50 and a console for controlling the modality 80. For example, the information processing system 100 according to the present embodiment can also be applied to a case where the modality 80 and a console thereof have already been installed and the robot 50 and a console thereof are newly added thereto.

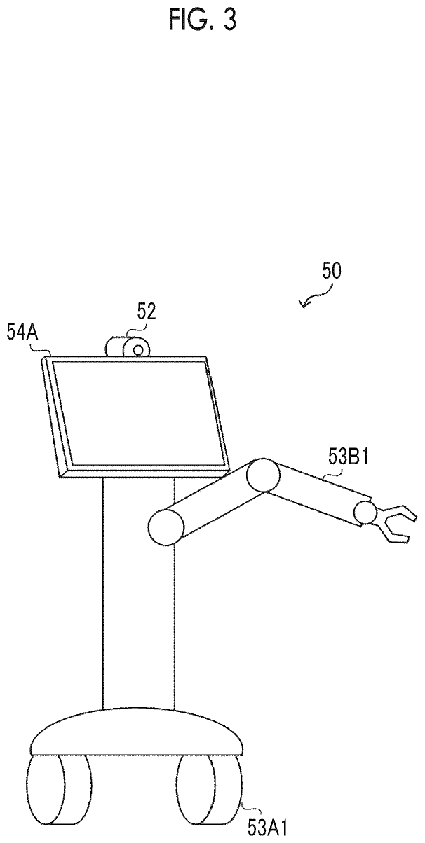

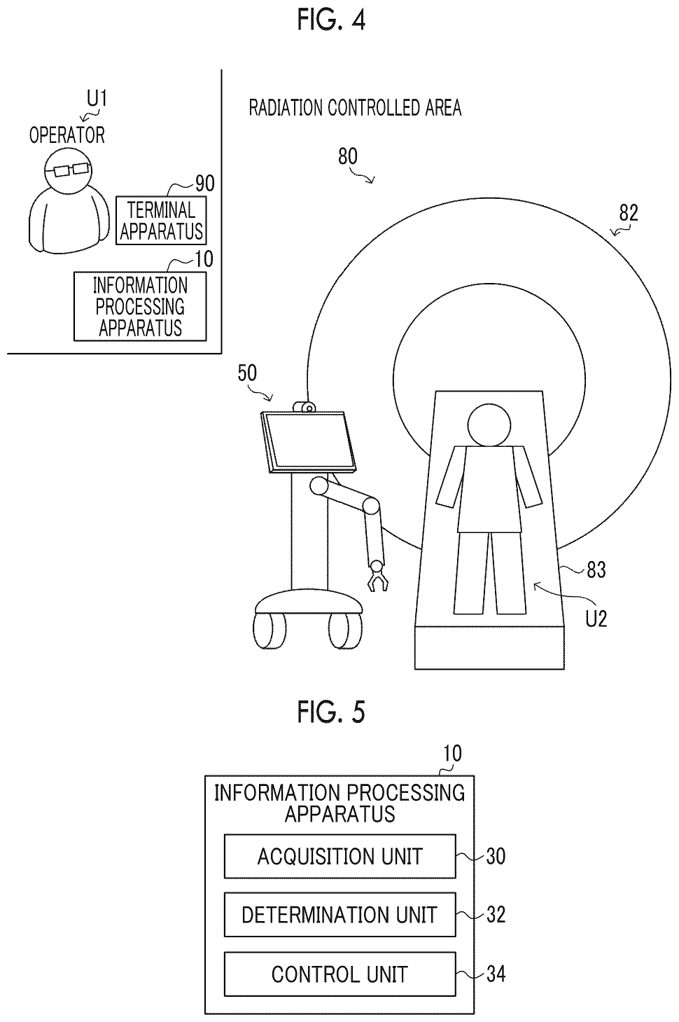

FIG. 3 is an example of a schematic diagram illustrating the appearance of the robot 50. In addition, FIG. 4 is an example of a schematic diagram illustrating a usage aspect of the robot 50 and the modality 80 illustrated in FIG. 3. The robot 50 illustrated in FIG. 3 comprises wheels 53A1 as an example of the movement mechanism 53A and a robot arm 53B1 as an example of the operation mechanism 53B. In addition, the robot 50 comprises the display 54A as an example of the output unit 54 and the detection unit 52 that is provided above the display 54A.

As illustrated in FIG. 4, a CT apparatus as an example of the modality 80 is provided in the radiation controlled area, the subject U2 lies down on the bed portion 83, and the robot 50 is disposed near the subject U2 to monitor the state of the subject U2. The robot 50 detects the image, motion, voice, and the like of the subject U2 using the detection unit 52 and transmits the detected information (that is, information indicating the state of the subject U2) to the information processing apparatus 10. Therefore, the operator U1 outside the radiation controlled area can monitor the state of the subject U2 in detail.

In addition, the robot 50 may display a face image of the operator U1 on the display 54A or output the voice of the operator U1 from the speaker 54B to communicate between the operator U1 and the subject U2. In this case, the operator U1 can also move the position of the robot 50 using the movement mechanism 53A to observe the state of the subject U2 well.

However, in the process of the radiography, the operator U1 may repeatedly enter and leave the radiation controlled area. For example, in a stage in which the operator U1 instructs the subject U2 on the positioning or posture required for imaging, goes outside the radiation controlled area, and operates the modality operation unit 25B to start imaging, the subject U2 may deviate from predetermined positioning for some reason. In this case, the operator U1 may return to the radiation controlled area again and re-performs the positioning of the subject U2.

In this situation, in a case where the robot 50 makes an unexpected motion for the operator U1 in a state in which the operator U1 is in the radiation controlled area, the motion of the robot 50 is likely to hinder the work of the operator U1, or the robot 50 and the operator U1 are likely to collide with each other. On the other hand, it is troublesome for the operator U1 to manually take measures to stop the robot 50 from moving every time the operator enters or leaves the radiation controlled area, and there is a possibility that the operator U1 will forget to take the measures.

Therefore, the information processing apparatus 10 according to the present embodiment automatically switches between a state in which the robot 50 is movable and a state in which the robot 50 is not movable according to the motion of the operator U1 to perform control such that the robot 50 does not make a motion that is not expected by the operator U1. Here, the state in which the robot 50 is movable means a state in which the movable unit 53 of the robot 50 is operable. Hereinafter, this state is referred to as an “operation mode”. On the other hand, the state in which the robot 50 is not movable means a state in which the movable unit 53 of the robot 50 is inoperable. Hereinafter, this state is referred to as a “non-operation mode”. Further, in the non-operation mode, the movable unit 53 of the robot 50 may be locked or may not be locked. The state in which the movable unit 53 of the robot 50 is not locked means that the robot 50 is moved in a case where the operator U1 directly touches and presses the robot 50.

Here, it is preferable that the non-operation mode is a mode in which functions other than the movable unit 53 comprised in the robot 50 are not stopped. For example, in some cases, it is preferable to continue the monitoring of the subject U2, that is, the detection and output of the detection information by the robot 50 regardless of whether the operator U1 is in or out of the radiation controlled area. Therefore, the information processing apparatus 10 may perform control such that the functions, such as the CPU 71, the output unit 54, and the detection unit 52, other than the movable unit 53 in the robot 50 are not stopped even in the non-operation mode.

Hereinafter, the information processing apparatus 10 will be described. An example of a functional configuration of the information processing apparatus 10 will be described with reference to FIG. 5. As illustrated in FIG. 5, the information processing apparatus 10 includes an acquisition unit 30, a determination unit 32, and a control unit 34. The CPU 21 executes the information processing program 27 to function as each of functional units of the acquisition unit 30, the determination unit 32, and the control unit 34.

### Switching of Mode of Robot 50

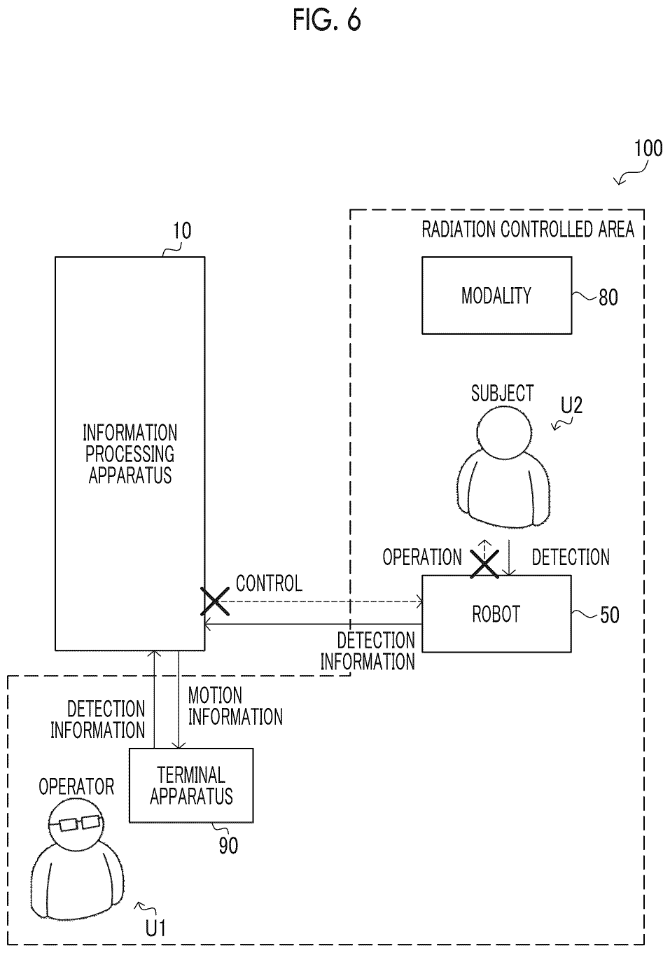

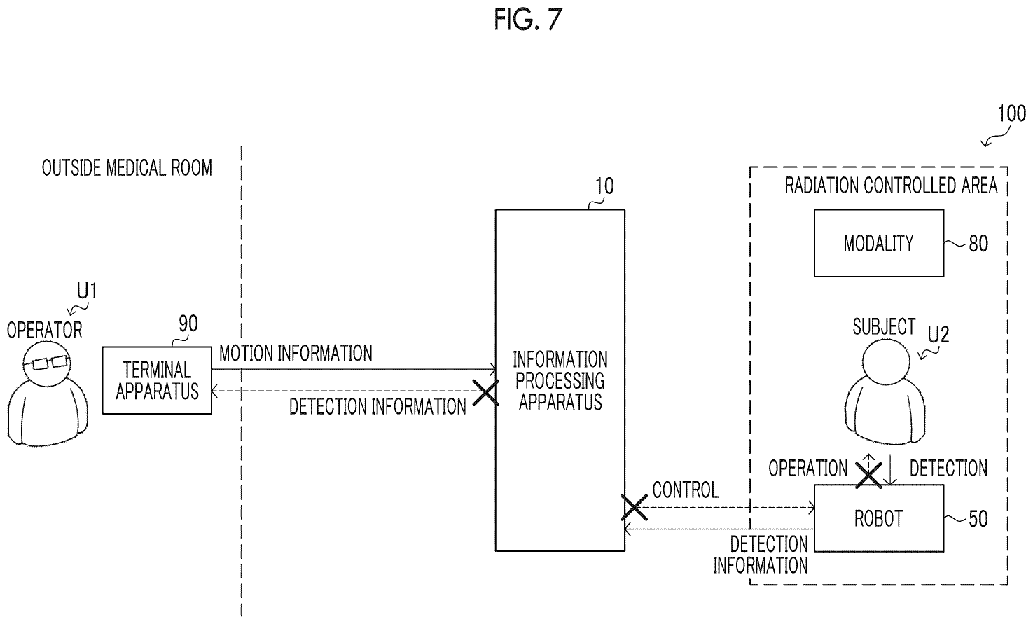

First, a process of switching the robot 50 between the operation mode and the non-operation mode according to the motion of the operator U1 will be described with reference to FIGS. 1, 6, and 7. FIG. 6 is a schematic diagram illustrating an example of an overall configuration of the information processing system 100 in a state in which the operator U1 enters the radiation controlled area. FIG. 7 is a schematic diagram illustrating an example of the overall configuration of the information processing system 100 in a state in which the operator U1 is away from both the radiation controlled area and a medical room in which the information processing apparatus 10 is located (a state in which the operator U1 leaves the medical room). FIG. 1 corresponds to the operation mode, and FIGS. 6 and 7 correspond to the non-operation mode.

The acquisition unit 30 acquires motion information indicating the motion of the operator U1 who operates the movable unit 53 of the robot 50. The motion information indicates, for example, the movement of at least one of a predetermined body part (for example, a hand, a foot, or the like), a line of sight, a voice, a brain wave, or a position of the operator U1.

The motion information may be detected by, for example, various sensors such as an acceleration sensor, a gyro sensor, a geomagnetic sensor, a line-of-sight sensor, a brain wave sensor, a temperature sensor, and a distance-measuring sensor. For example, the operator U1 may be imaged by a camera, and the obtained video image may be analyzed to detect the motion information. In addition, for example, the motion information may be detected by collecting the utterance of the operator U1 and the surrounding sound with a microphone and analyzing the obtained voice.

For example, the detection unit 92 provided in the terminal apparatus 90 owned by the operator U1 may be used as the various sensors, the camera, the microphone, and the like for detecting the motion information, or various sensors, the camera, the microphone, and the like may be provided in the room in which the information processing apparatus 10 is disposed and the radiation controlled area. For example, FIG. 1 illustrates that the motion information is acquired from the detection unit 92 of the terminal apparatus 90.

The determination unit 32 determines whether or not the motion information acquired by the acquisition unit 30 satisfies a predetermined first condition. For example, the determination unit 32 may determine whether or not the operator U1 and the robot 50 are in a situation in which they can physically interfere with each other on the basis of the motion information.

Specifically, the determination unit 32 may determine whether or not the motion information indicates that the operator U1 has entered a predetermined area as the first condition. In the present embodiment, the predetermined area is an area in which the robot 50 is operated and is the radiation controlled area. In other words, the determination unit 32 may determine whether or not the motion information indicates that the operator U1 has entered an area within a predetermined range from the robot 50 (see FIG. 6).

In addition, for example, it is considered that, in a state in which the operator U1 leaves the medical room, the operator U1 does not intend to control the robot 50 as illustrated in FIG. 7. Therefore, for example, the determination unit 32 may determine whether or not the operator U1 is in a situation in which the operator U1 does not desire to control the robot 50, on the basis of the motion information. Specifically, the determination unit 32 may determine whether or not the motion information indicates that the operator U1 is a predetermined distance away from the robot 50 as the first condition.

In a case where the determination result of the determination unit 32 is “Yes” (that is, in a case where the motion information satisfies the first condition), the control unit 34 controls the robot 50 such that the robot 50 is switched from the operation mode to the non-operation mode. According to this form, for example, in a case where the operator U1 has entered a predetermined area, it is possible to switch the mode to the non-operation mode. Therefore, it is possible to prevent the robot 50 from making a movement that is not expected by the operator U1.

In addition, in a case where the motion information does not satisfy the first condition in a state in which the mode is switched to the non-operation mode, the control unit 34 may control the robot 50 such that the robot 50 is returned from the non-operation mode to the operation mode. According to this form, for example, after the operator U1 leaves the radiation controlled area, the robot 50 can be operated again.

### Control of Robot 50

Next, a difference between the control processes of the robot 50 in the operation mode and the non-operation mode will be described.

As illustrated in FIG. 1, the acquisition unit 30 acquires the operation information for the movable unit 53 of the robot 50 which is input by the operator U1 through the robot operation unit 25A. The operation information may be input by, for example, voice.

Further, for example, the operation information may be information that is operatively associated with the behavior of the body, such as the hand or the foot, of the operator U1. In this case, the acquisition unit 30 may generate operation information causing the movable unit 53 of the robot 50 to be operated in operative association with the motion information, using the motion information of the operator U1. For example, in a case where the motion information indicates a predetermined gesture, the acquisition unit 30 may generate the operation information for causing the robot 50 to perform a predetermined behavior corresponding to the gesture. In addition, for example, the acquisition unit 30 may specify the movement direction and movement distance of the operator U1 on the basis of the motion information and generate the operation information for causing the robot 50 to be moved by the same distance in the same direction.

In the operation mode, the control unit 34 controls the robot 50 such that the robot 50 makes a motion corresponding to the operation information acquired by the acquisition unit 30. That is, the control unit 34 controls the robot 50 such that the movable unit 53 of the robot 50 is moved according to the operation information.

On the other hand, in a case of the non-operation mode, the control unit 34 discards the operation information acquired by the acquisition unit 30 to prevent the robot 50 from making a motion that is not expected by the operator U1. In the present embodiment, as described above, it is possible to use the operation information based on the motion information of the operator U1. Even in the non-operation mode, the motion information may be continuously acquired for the mode switching process (see FIGS. 6 and 7). In this case, the acquisition unit 30 may generate the operation information that is not intended by the operator U1 on the basis of the motion information. Therefore, in the non-operation mode, the control unit 34 discards the operation information to prevent the robot 50 from moving.

### Monitoring of Subject U2

Next, a process of monitoring the subject U2 will be described.

As illustrated in FIG. 1, the acquisition unit 30 acquires the detection information of the subject U2 acquired by the detection unit 52 of the robot 50. The control unit 34 outputs the detection information acquired by the acquisition unit 30 to at least one output device. The output device is, for example, the output unit 94 (the display 94A, the speaker 94B, and the like) of the terminal apparatus 90. In this case, the control unit 34 may perform a predetermined process on the detection information and then output the detection information. For example, in a case in which the detection information is the video image of the subject U2 captured by the camera 52B, the control unit 34 may perform a process of enlarging a face portion of the subject U2.

As illustrated in FIG. 6, the output of the detection information to the terminal apparatus 90 (the process of monitoring the subject U2) may be performed even in a case where the robot 50 is in the non-operation mode. For example, the reason is that, even in a case in which the operator U1 is in the radiation controlled area, it may be preferable to continue the detection and output of the detection information by the robot 50 because it is easier for the robot 50 to monitor the subject U2 at a close position.

On the other hand, as illustrated in FIG. 7, in a state in which the operator U1 leaves the medical room, the output of the detection information to the terminal apparatus 90 (the process of monitoring the subject U2) may not be performed. The reason is that this may occur, for example, in a case where the operator U1 is replaced with another person and the original operator U1 leaves the radiography work.

Specifically, the determination unit 32 may determine whether or not the motion information of the operator U1 satisfies a predetermined second condition. For example, the determination unit 32 may determine whether or not the motion information indicates that the operator U1 is a predetermined distance away from the robot 50 as the second condition. In a case where the determination result of the determination unit 32 is “Yes” (that is, in a case where the motion information satisfies the second condition), the control unit 34 may stop the output of the detection information to the terminal apparatus 90.

### Control of Modality 80

Next, a process of controlling the modality 80 will be described.

As illustrated in FIG. 1, the acquisition unit 30 receives an operation instruction for the modality 80 which is input by the operator U1 through the modality operation unit 25B. The control unit 34 controls the modality 80 such that the modality 80 performs an operation corresponding to the operation instruction for the modality 80 acquired by the acquisition unit 30. Examples of the operation instruction for the modality 80 include an instruction to change imaging conditions in radiography and an instruction to start radiography.

The operation instruction for the modality 80 may be, for example, an instruction input by voice. In addition, for example, the operation instruction may be an instruction that is operatively associated with the behavior of the body, such as the hand or the foot, of the operator U1. In this case, the acquisition unit 30 may generate an operation instruction causing the modality 80 to be operated according to the motion information, using the motion information of the operator U1. For example, in a case where the motion information indicates a predetermined gesture, the acquisition unit 30 may generate an operation instruction for causing the modality 80 to emit radiation.

On the other hand, in a state in which the operator U1 enters the radiation controlled area as illustrated in FIG. 6, the operator U1 does not originally operate the modality 80. However, in the information processing system 100 according to the present embodiment, as described above, the robot 50 may have the functions of the modality operation unit 25B. In this case, the control unit 34 may transmit information indicating the non-operation mode to the modality 80 and may stop a part or all of the operation of the modality 80. For example, the control unit 34 may permit a change in a display method on the display 24A, but may prohibit the start of the radiography in which the operator U1 can be exposed to radiation.

Similarly, it is considered that, even in a state in which the operator U1 leaves the medical room as illustrated in FIG. 7, the operator U1 does not operate the modality 80. Similarly, it is considered that the operator U1 does not operate the robot 50. However, in a case where the robot 50 and the modality 80 are operated according to the motion information, it is preferable to stop a part or all of the operation of the modality 80 in order to prevent the operator U1 from unintentionally operating the robot 50 and the modality 80.

As described above, since the modality 80 and the robot 50 are controlled by one information processing apparatus 10, a cooperative process that enables smooth communication between the operator U1 and the subject U2 can also be performed between the robot 50 and the modality 80. For example, it is considered that, even in a case where communication is performed through the robot 50 for the first time, it is difficult to perform the communication during the radiography by the modality 80 (CT apparatus) since the subject U2 moves in a bore and is distant from the robot 50. In this case, the CT apparatus can also be used in such a way that the devices are switched to a camera, a microphone, and a display (which are not illustrated in FIG. 2, and, for example, the imaging unit 82 may be comprised) installed in the bore of the CT apparatus to continuously perform communication before, during, and after radiography.

In addition, in a case where the operator U1 performs an operation, such as positioning, near the subject U2, the operator U1 may want to check console information of the modality 80. In this case, the output information of the modality 80 may be displayed on the output unit 54 of the robot 50. Further, an operation input to the modality 80 or the like may be performed using the input unit 55 of the robot 50. In this case, it is preferable to perform control such that the start of imaging based on the motion information of the operator U1 is not permitted.

Further, the information processing apparatus 10 may acquire the detection information (for example, the image of the posture related to the positioning) of the subject U2 detected by the detection unit 52 of the robot 50 and record the detection information in association with the radiographic image captured by the modality 80 and the imaging conditions thereof.

In addition, it is also considered that the movable bed portion 83 of the modality 80 is moved and collides with the robot 50 from a positional relationship between the robot 50 and the bed portion 83. Therefore, the information processing apparatus 10 may determine whether or not the robot 50 is staying on a movement route in a case where the bed portion 83 is moved or whether or not a movement position is within the movement route of the bed portion 83 of the modality 80 in a case where the operator U1 moves the robot 50 during imaging, on the basis of the positional information of the robot 50. Then, in a case where the bed portion 83 and the robot 50 can come into contact with each other, a warning may be issued, or the movement of the robot 50 may be restricted.

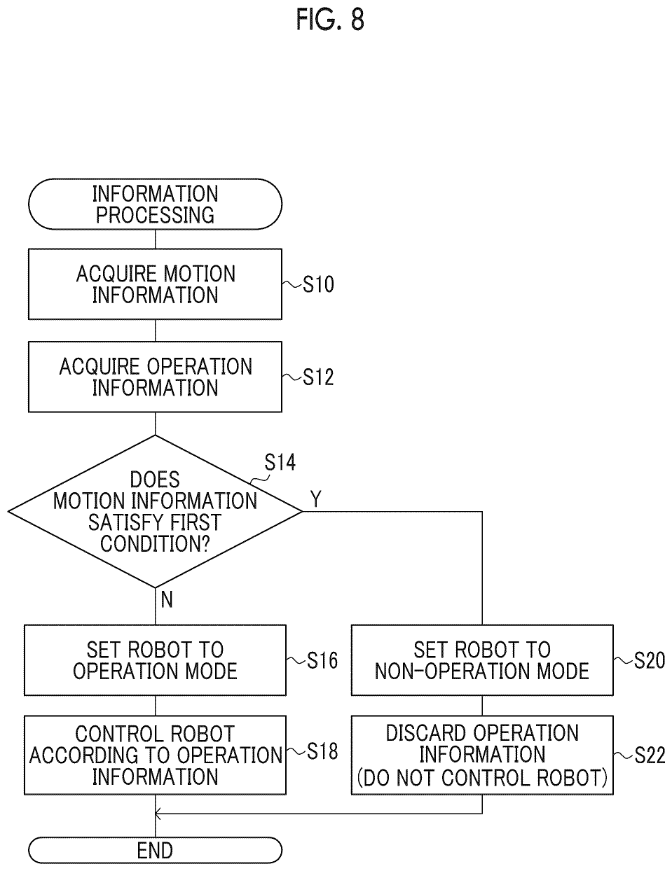

Next, the operation of the information processing apparatus 10 according to the present embodiment will be described with reference to FIG. 8. In the information processing apparatus 10, in a case in which the CPU 21 executes the information processing program 27, information processing illustrated in FIG. 8 is executed. The information processing is executed, for example, in a case where the user inputs an execution start instruction through the input unit 25.

In Step S10, the acquisition unit 30 acquires motion information indicating the motion of the operator U1 who operates the movable unit 53 of the robot 50. In Step S12, the acquisition unit 30 acquires operation information for the movable unit 53 of the robot 50 which is input by the operator U1. In Step S14, the determination unit 32 determines whether or not the motion information acquired in Step S10 satisfies the predetermined first condition.

In a case where the determination result in Step S14 is “No” (that is, in a case where the motion information does not satisfy the first condition), the process proceeds to Step S16. In Step S16, the control unit 34 sets the mode to the operation mode in which the movable unit 53 of the robot 50 is operable. In Step S18, the control unit 34 controls the robot 50 such that the robot 50 makes a motion corresponding to the operation information acquired in Step S12 and ends this information processing.

On the other hand, in a case where the determination result in Step S14 is “Yes” (that is, in a case where the motion information satisfies the first condition), the process proceeds to Step S20. In Step S20, the control unit 34 sets the mode to the non-operation mode in which the movable unit 53 of the robot 50 is inoperable. In Step S22, the control unit 34 discards the operation information acquired in Step S12 (that is, the control unit 34 does not control the robot 50) and ends this information processing.

As described above, the information processing system 100 according to an aspect of the present disclosure comprises at least one processor. The processor is configured to: acquire the motion information indicating the motion of the operator U1 who operates the movable unit 53 of the robot 50; and control the robot 50 such that the robot 50 is switched from the operation mode in which the movable unit 53 is in an operable state to the non-operation mode in which the movable unit 53 is in an inoperable state in a case where the motion information satisfies the predetermined first condition.

That is, according to the information processing system 100 of the present embodiment, it is possible to prevent the robot 50 from making a motion that is not expected by the operator U1 on the basis of the motion of the operator U1. Therefore, it is possible to appropriately operate the robot 50.

### Second Embodiment

In radiography, for example, in some cases, an assistant U3 who assists work, such as positioning, assists the subject U2, or attends the subject U2 also enters and leaves the radiation controlled area. In this case, it is desirable to prevent the robot 50 from making an unexpected motion for the assistant U3 similarly to the operator U1.

Therefore, the information processing apparatus 10 according to the present embodiment performs control to automatically switch the robot 50 between the operation mode and the non-operation mode according to the motion of the assistant U3 in addition to the motion of the operator U1 to prevent the robot 50 from making a motion that is not expected by the assistant U3.

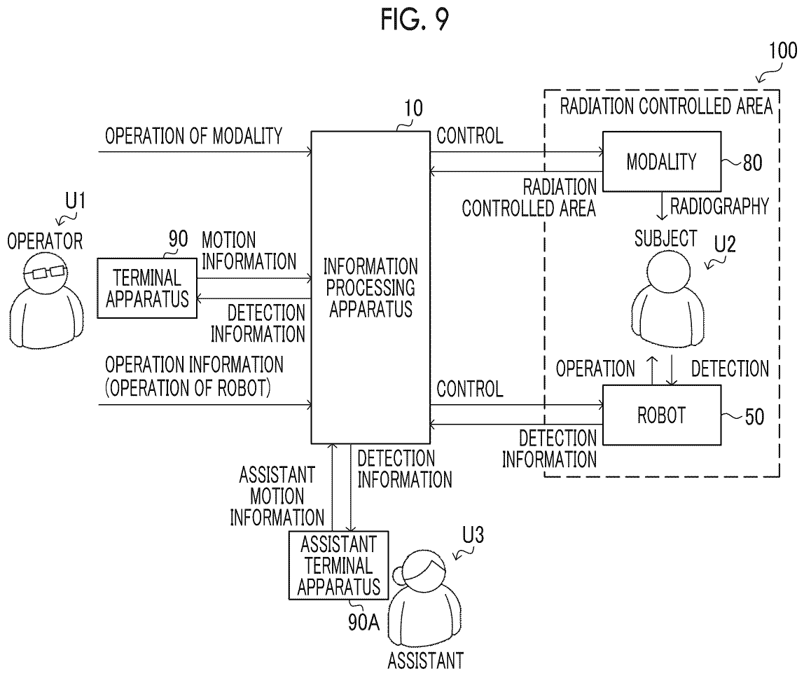

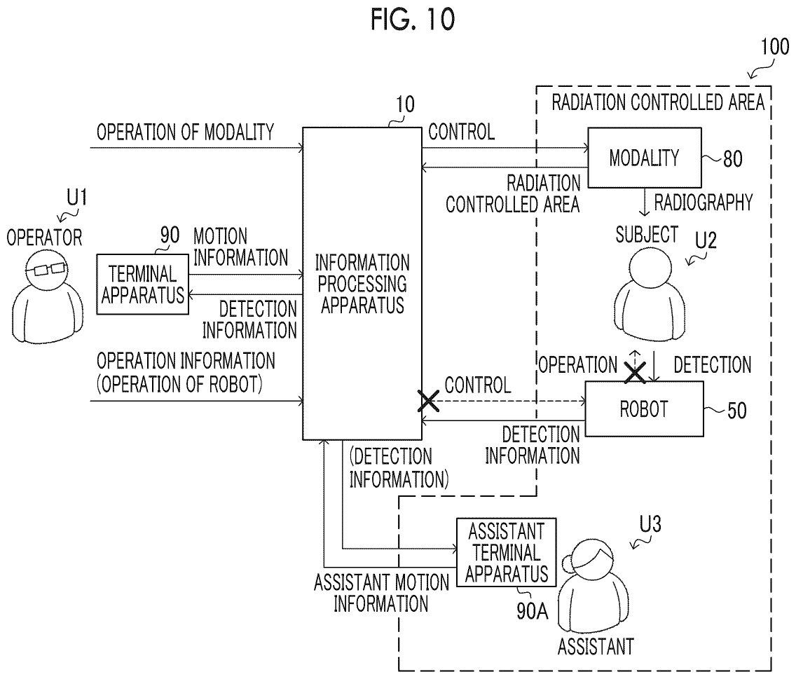

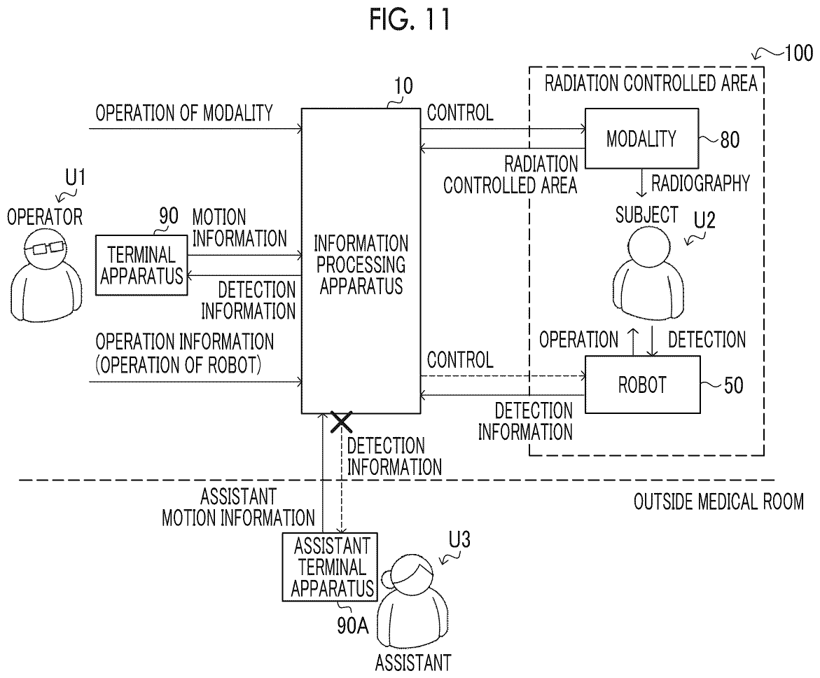

Hereinafter, the functions of the information processing apparatus 10 according to the present embodiment will be described with reference to FIGS. 9 to 11. However, a portion of the description overlapping with the first embodiment will be omitted. FIG. 9 is a schematic diagram illustrating an example of the overall configuration of the information processing system 100 according to the present embodiment and is different from FIG. 1 in that the assistant U3 is added. FIG. 10 is a schematic diagram illustrating an example of the overall configuration of the information processing system 100 in a state in which the assistant U3 enters the radiation controlled area. FIG. 11 is a schematic diagram illustrating an example of the overall configuration of the information processing system 100 in a state in which the assistant U3 is away from both the radiation controlled area and the medical room in which the information processing apparatus 10 is located (a state in which the assistant U3 leaves the medical room). FIGS. 9 and 11 correspond to the operation mode, and FIG. 10 corresponds to the non-operation mode.

### Switching of Mode of Robot 50

First, a process of switching the robot 50 between the operation mode and the non-operation mode according to the motion of the assistant U3 will be described.

The acquisition unit 30 acquires assistant motion information indicating the motion of the assistant U3. The assistant U3 is a person other than the operator U1 and is a person who can enter and leave the radiation controlled area. The assistant motion information is, for example, information indicating the movement of at least one of a predetermined body part (for example, a hand, a foot, or the like), a line of sight, voice, a brain wave, or a position of the assistant U3. The assistant motion information can be detected by, for example, various sensors, a camera, a microphone, and the like provided in an assistant terminal apparatus 90A owned by the assistant U3, similarly to the motion information of the operator U1.

The determination unit 32 determines whether or not the assistant motion information acquired by the acquisition unit 30 satisfies a predetermined third condition. For example, the determination unit 32 may determine whether or not the assistant U3 and the robot 50 are in a situation in which they can physically interfere with each other, on the basis of the assistant motion information. Specifically, the determination unit 32 may determine whether or not the assistant motion information indicates that the assistant U3 has entered a predetermined area (radiation controlled area) as the third condition (see FIG. 10).

In a case where the determination result of the determination unit 32 is “Yes” (that is, in a case where the assistant motion information satisfies the third condition), the control unit 34 controls the robot 50 such that the robot 50 is switched from the operation mode to the non-operation mode. According to this form, for example, in a case where the assistant U3 has entered the predetermined area, it is possible to switch the mode to the non-operation mode. Therefore, it is possible to prevent the robot 50 from making a motion that is not expected by the assistant U3.

In addition, in a case where the assistant motion information does not satisfy the third condition in a state in which the mode is switched to the non-operation mode, the control unit 34 may control the robot 50 such that the robot 50 is returned from the non-operation mode to the operation mode. According to this form, for example, after the assistant U3 leaves the radiation controlled area, the robot 50 can be operated again.

### Control of Robot 50

The operator U1 inputs operation information to control the robot 50 as in the first embodiment. That is, the assistant U3 does not usually operate the robot 50.

In addition, as illustrated in FIG. 10, in a state in which the assistant U3 enters a predetermined area (radiation controlled area), it is preferable that the control unit 34 discards the operation information for the robot 50 even in a case where the operator U1 inputs the operation information. The reason is that, in some cases, the robot 50 makes a motion that is not intended by the assistant U3 even though the operation is intended by the operator U1.

On the other hand, as illustrated in FIG. 11, in a state in which the assistant U3 is a predetermined distance away from the robot 50, the control unit 34 may perform control such that the movable unit 53 of the robot 50 is moved according to the operation information for the robot 50 input by the operator U1. The reason is that it is considered that the assistant U3 and the robot 50 do not interfere with each other in this case.

### Monitoring of Subject U2

Instead of or in addition to the operator U1, the assistant U3 may monitor the subject U2. Specifically, the control unit 34 may output the detection information acquired by the acquisition unit 30 to at least one of a first output device (terminal apparatus 90) associated with the operator U1 in advance or a second output device (assistant terminal apparatus 90A) associated with the assistant U3 in advance. The assistant terminal apparatus 90A is, for example, a smartphone, a wearable terminal, a tablet terminal, a personal computer, or the like. Examples of the wearable terminal include a head-mounted display, smart glasses, and a smart watch. The terminal apparatus 90 and the assistant terminal apparatus 90A may be apparatuses of different types. Since the hardware configuration of the assistant terminal apparatus 90A is the same as that of the terminal apparatus 90 (see FIG. 2), the description thereof will not be repeated.

As illustrated in FIG. 10, the output of the detection information to the assistant terminal apparatus 90A (the process of monitoring the subject U2) may be performed even in a case in which the robot 50 is in the non-operation mode. For example, the reason is that, even in a case in which the assistant U3 is in the radiation controlled area, it may be preferable to continue the detection and output of the detection information by the robot 50 because it is easier for the robot 50 to monitor the subject U2 at a close position.

On the other hand, as illustrated in FIG. 11, in a state in which the assistant U3 leaves the medical room, the output of the detection information to the assistant terminal apparatus 90A (the process of monitoring the subject U2) may not be performed. The reason is that this may occur, for example, in a case where the assistant U3 is replaced with another person and the original assistant U3 leaves the radiography work.

The determination unit 32 may determine whether or not the assistant motion information satisfies a predetermined fourth condition. For example, the determination unit 32 may determine whether or not the assistant motion information indicates that the assistant U3 is a predetermined distance away from the robot 50 as the fourth condition. In a case where the determination result of the determination unit 32 is “Yes” (that is, in a case where the assistant motion information satisfies the fourth condition), the control unit 34 may stop the output of the detection information to the assistant terminal apparatus 90A.

### Control of Modality 80

As described above, it is preferable to switch the robot 50 between the operation mode and the non-operation mode in consideration of the motions of both the operator U1 and the assistant U3. On the other hand, the modality 80 may be controlled in response to the operation instruction of the operator U1 regardless of the motion of the assistant U3. For example, in a case where the subject U2 is a child, radiography may be performed in a state in which the assistant U3 (for example, a parent of the child) stays in the radiation controlled area together with the subject U2.

According to the information processing system 100 of the present embodiment, it is possible to prevent the robot 50 from making unexpected motions for both the operator U1 and the assistant U3 on the basis of the motions of both the operator U1 and the assistant U3. Therefore, it is possible to appropriately operate the robot 50.

Further, in each of the above-described embodiments, the example in which the CT apparatus is applied as an example of the modality 80 has been described. However, the present disclosure is not limited thereto. For example, a simple X-ray imaging apparatus, an X-ray fluoroscopy apparatus, mammography, a bone mineral density measurement apparatus, a magnetic resonance imaging (MRI) apparatus, a positron emission tomography (PET) apparatus, a radiation therapy apparatus, or the like can be appropriately applied as the modality 80.

In addition, in each of the above-described embodiments, the form has been described in which the determination unit 32 determines whether or not at least one of the operator U1 or the assistant U3 has entered the radiation controlled area to switch the mode to the non-operation mode. However, the present disclosure is not limited thereto. For example, at least one of a high magnetic field controlled area (for example, an MRI room), a biohazard controlled area, an aseptic room, an intensive care room, or a clean room may be applied instead of the radiation controlled area.

In addition, in each of the above-described embodiments, the form has been described in which the operator U1 and the assistant U3 monitor the aspect (detection information) of the subject U2. However, a configuration may be adopted in which the subject U2 can check the aspects of the operator U1 and the assistant U3. That is, a configuration may be adopted in which the operator U1, the assistant U3, and the subject U2 can check their aspects in both directions. For example, the control unit 34 may perform control such that the output unit 54 (the display 54A and the speaker 54B) of the robot 50 outputs the motion information of the operator U1 and the assistant motion information of the assistant U3 acquired by the acquisition unit 30. According to this form, the subject U2 remaining in the radiation controlled area during the emission of radiation can check the aspects of the operator U1 and the assistant U3. Therefore, it is possible to reduce a feeling of anxiety.

In addition, in each of the above-described embodiments, the form has been described in which the detection information of the subject U2 detected by the robot 50 is output to the terminal apparatus 90 of the operator U1 and the assistant terminal apparatus 90A of the assistant U3. However, the present disclosure is not limited thereto. For example, in addition to or instead of the output to the terminal apparatus 90 and the assistant terminal apparatus 90A, control may be performed such that the detection information is displayed on the display 24A of the information processing apparatus 10, and the operator U1 and the assistant U3 may check the display 24A to monitor the aspect of the subject U2.

Further, in each of the above-described embodiments, the form has been described in which the CPU 21 of the information processing apparatus 10 functions as the acquisition unit 30, the determination unit 32, and the control unit 34. However, the present disclosure is not limited thereto. For example, each of the robot 50, the modality 80, the terminal apparatus 90, and the assistant terminal apparatus 90A may function as at least some of the acquisition unit 30, the determination unit 32, and the control unit 34.

Furthermore, in the above-described embodiments, for example, the following various processors can be used as a hardware structure of processing units executing various processes, such as the acquisition unit 30, the determination unit 32, and the control unit 34. The various processors include, for example, the CPU which is a general-purpose processor executing software (program) to function as various processing units as described above, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process.

One processing unit may be configured by one of the various processors or a combination of two or more processors of the same type or different types (for example, a combination of a plurality of FPGAs or a combination of a CPU and an FPGA). Further, a plurality of processing units may be configured by one processor.

A first example of the configuration in which a plurality of processing units are configured by one processor is an aspect in which one processor is configured by a combination of one or more CPUs and software and functions as a plurality of processing units. A representative example of this aspect is a client computer or a server computer. Second, as represented by a system on chip (SoC) or the like, there is a form in which the processor is used in which the functions of the entire system which includes the plurality of processing units are realized by a single integrated circuit (IC) chip. As described above, the various processing units are configured by using one or more of the above various processors as the hardware structure.

In addition, more specifically, an electric circuit (circuitry) in which circuit elements, such as semiconductor elements, are combined can be used as the hardware structure of these various processors.

Further, in the above-described embodiments, the aspect has been described in which various programs are stored in the storage unit in advance. However, the present disclosure is not limited thereto. The various programs may be recorded on a recording medium, such as a compact disc read only memory (CD-ROM), a digital versatile disc read only memory (DVD-ROM), or a universal serial bus (USB) memory, and then provided. In addition, the various programs may be downloaded from an external apparatus via the network. Furthermore, the technology of the present disclosure extends to a storage medium that non-temporarily stores the program, in addition to the program.

In the technology of the present disclosure, the above-described embodiments and examples can also be combined as appropriate. The contents described and illustrated above are detailed descriptions of portions according to the technology of the present disclosure and are only examples of the technology of the present disclosure. For example, the description of the configurations, functions, operations, and effects is the description of examples of the configurations, functions, operations, and effects of portions related to the technology of the present disclosure. Therefore, unnecessary portions may be deleted or new elements may be added or replaced in the contents described and illustrated above, without departing from the gist of the technology of the present disclosure.

For the above-described embodiments, the following supplementary notes are further disclosed.

### Supplementary Note 1

An information processing system comprising:
at least one processor configured to:
acquire motion information indicating a motion of an operator who operates a movable unit of a robot; and
control the robot such that the robot is switched from an operation mode in which the movable unit is in an operable state to a non-operation mode in which the movable unit is in an inoperable state in a case where the motion information satisfies a predetermined first condition.

### Supplementary Note 2

The information processing system according to Supplementary Note 1,
wherein the processor is configured to:
acquire operation information for the movable unit that is input by the operator;
control the robot such that the robot makes a motion corresponding to the operation information in a case of the operation mode; and
discard the operation information in a case of the non-operation mode.

### Supplementary Note 3

The information processing system according to Supplementary Note 2,
wherein the processor is configured to:
generate the operation information causing the movable unit to be operated in operative association with the motion information in a case of the operation mode.

### Supplementary Note 4

The information processing system according to any one of Supplementary Notes 1 to 3,
wherein the processor is configured to:
control the robot such that the robot is switched from the operation mode to the non-operation mode in a case where the motion information indicates that the operator has entered a predetermined area as the first condition.

### Supplementary Note 5

The information processing system according to Supplementary Note 4,
wherein the predetermined area is an area within a predetermined range from the robot.

### Supplementary Note 6

The information processing system according to Supplementary Note 4 or 5,
wherein the predetermined area is at least one of a radiation controlled area, a high magnetic field controlled area, a biohazard controlled area, an aseptic room, an intensive care room, or a clean room, and
the robot is operated in the predetermined area.

### Supplementary Note 7

The information processing system according to any one of Supplementary Notes 1 to 6,
wherein the robot includes a detection unit of at least one of a sensor, a camera, or a microphone, and
the processor is configured to:
acquire detection information acquired by the detection unit of the robot; and
output the detection information to at least one output device.

### Supplementary Note 8

The information processing system according to Supplementary Note 7,
wherein the processor is configured to:
stop the output of the detection information to the output device in a case where the motion information satisfies a predetermined second condition.

### Supplementary Note 9

The information processing system according to any one of Supplementary Notes 1 to 8,
wherein the processor is configured to:
acquire assistant motion information indicating a motion of an assistant other than the operator; and
control the robot such that the robot is switched from the operation mode to the non-operation mode in a case where the assistant motion information satisfies a predetermined third condition.

### Supplementary Note 10

The information processing system according to Supplementary Note 7,
wherein the processor is configured to:
output the detection information to a first output device associated with the operator in advance and a second output device associated with an assistant other than the operator in advance;
acquire assistant motion information indicating a motion of the assistant; and
stop the output of the detection information to the second output device in a case where the assistant motion information satisfies a predetermined fourth condition.

### Supplementary Note 11

The information processing system according to any one of Supplementary Notes 1 to 10,
wherein a function other than the movable unit included in the robot is not stopped in the non-operation mode.

### Supplementary Note 12

The information processing system according to any one of Supplementary Notes 1 to 11,
wherein the robot includes at least one of a movement mechanism or an operation mechanism as the movable unit.

### Supplementary Note 13

The information processing system according to any one of Supplementary Notes 1 to 12,
wherein the motion information indicates a movement of at least one of a predetermined body part, a line of sight, a voice, a brain wave, or a position of the operator.

### Supplementary Note 14

An information processing method executed by a computer, the method comprising:
acquiring motion information indicating a motion of an operator who operates a movable unit of a robot; and
controlling the robot such that the robot is switched from an operation mode in which the movable unit is in an operable state to a non-operation mode in which the movable unit is in an inoperable state in a case where the motion information satisfies a predetermined first condition.

### Supplementary Note 15

An information processing program causing a computer to execute a process comprising:
acquiring motion information indicating a motion of an operator who operates a movable unit of a robot; and
controlling the robot such that the robot is switched from an operation mode in which the movable unit is in an operable state to a non-operation mode in which the movable unit is in an inoperable state in a case where the motion information satisfies a predetermined first condition.

What is claimed is:

1. An information processing system comprising at least one processor, wherein the processor is configured to:
acquire motion information indicating a motion of an operator who operates a movable unit of a robot; and
control the robot such that the robot is switched from an operation mode in which the movable unit is in an operable state to a non-operation mode in which the movable unit is in an inoperable state in a case where the motion information satisfies a predetermined first condition.

2. The information processing system according to claim 1, wherein the processor is configured to:
acquire operation information for the movable unit that is input by the operator;
control the robot such that the robot makes a motion corresponding to the operation information in a case of the operation mode; and
discard the operation information in a case of the non-operation mode.

3. The information processing system according to claim 2, wherein the processor is configured to generate the operation information causing the movable unit to be operated in operative association with the motion information in a case of the operation mode.

4. The information processing system according to claim 1, wherein the processor is configured to control the robot such that the robot is switched from the operation mode to the non-operation mode in a case where the motion information indicates that the operator has entered a predetermined area as the first condition.

5. The information processing system according to claim 4, wherein the predetermined area is an area within a predetermined range from the robot.

6. The information processing system according to claim 4, wherein:
the predetermined area is at least one of a radiation controlled area, a high magnetic field controlled area, a biohazard controlled area, an aseptic room, an intensive care room, or a clean room, and
the robot is operated in the predetermined area.

7. The information processing system according to claim 1, wherein:
the robot includes a detection unit of at least one of a sensor, a camera, or a microphone, and
the processor is configured to:
acquire detection information acquired by the detection unit of the robot; and
output the detection information to at least one output device.

8. The information processing system according to claim 7, wherein the processor is configured to stop the output of the detection information to the output device in a case where the motion information satisfies a predetermined second condition.

9. The information processing system according to claim 1, wherein the processor is configured to:
acquire assistant motion information indicating a motion of an assistant other than the operator; and
control the robot such that the robot is switched from the operation mode to the non-operation mode in a case where the assistant motion information satisfies a predetermined third condition.

10. The information processing system according to claim 7, wherein the processor is configured to:
output the detection information to a first output device associated with the operator in advance and a second output device associated with an assistant other than the operator in advance;
acquire assistant motion information indicating a motion of the assistant; and
stop the output of the detection information to the second output device in a case where the assistant motion information satisfies a predetermined fourth condition.

11. The information processing system according to claim 1, wherein a function other than the movable unit included in the robot is not stopped in the non-operation mode.

12. The information processing system according to claim 1, wherein the robot includes at least one of a movement mechanism or an operation mechanism as the movable unit.

13. The information processing system according to claim 1, wherein the motion information indicates a movement of at least one of a predetermined body part, a line of sight, a voice, a brain wave, or a position of the operator.

14. An information processing method executed by a computer, the method comprising:
acquiring motion information indicating a motion of an operator who operates a movable unit of a robot; and
controlling the robot such that the robot is switched from an operation mode in which the movable unit is in an operable state to a non-operation mode in which the movable unit is in an inoperable state in a case where the motion information satisfies a predetermined first condition.

15. A non-transitory computer-readable storage medium storing an information processing program causing a computer to execute a process comprising:
acquiring motion information indicating a motion of an operator who operates a movable unit of a robot; and
controlling the robot such that the robot is switched from an operation mode in which the movable unit is in an operable state to a non-operation mode in which the movable unit is in an inoperable state in a case where the motion information satisfies a predetermined first condition.
